(19) United States
(12) Patent Application Publication
(10) Pub. No.: US 2005/0249543 A1
(43) Pub. Date: Nov. 10, 2005

(54) Loose-leaf binder

(76) Inventor: Sun L. Chang, Taichung (TW)

Correspondence Address: Troxell Law Office PLLC, Suite 1404, 5205 Leesburg Pike, Falls Church, VA, 22041, US

(21) Appl. No.: 10/838,192

(22) Filed: May 5, 2004

(51) Int. Cl. B42F 3/00

(52) U.S. Cl. 402/60

(57) ABSTRACT

A loose-leaf binder has a back, a binder made of a flexible material and attached to the back and two end plugs mounted respectively in ends of the back. The back has two tracks, two side slots and a middle slot. The binder has multiple open rings having two ends. Each plug has two side tines and a middle tine. A notebook with the loose-leaf papers can be easily attached to or detached from the loose-leaf binder by attaching or detaching the open rings of the binder to punched holes in the notebook simultaneously.

### BACKGROUND OF THE INVENTION

1. Field of the Invention

The present invention relates to a binder, and more particularly to a binder for loose-leaf paper.

2. Description of Related Art

With reference to FIG. 5, a conventional loose-leaf binder in accordance with the prior art is a binder (70) that is a flexible spiral coil. The binder (70) has two ends (not numbered) and is attached to a notebook (60) having loose-leaf paper (not numbered) through multiple punched holes (61). The binder (70) is attached to the notebook (60) by passing one end of the binder (70) sequentially through all the punched holes (61) in the loose-papers. However, one loose-leaf sheet of paper cannot be removed from the binder (70) without tearing the loose-leaf sheet of paper unless the binder (70) is completely removed from all the through holes (61) in the notebook (60) first. Therefore, inserting and removing sheets of paper from the binder is time consuming.

To overcome the shortcomings, the present invention provides an improved loose-leaf binder to mitigate or obviate the aforementioned problems.

### SUMMARY OF THE INVENTION

The main objective of the invention is to provide a loose-leaf binder that allows sheets of loose-leaf paper to be quickly and easily inserted into or removed from the binder by hand.

A loose-leaf binder in accordance with the present invention comprises a back, a binder and two end plugs.

The back has two ends, two longitudinal side slots and a middle slot. The binder has multiple open rings mounted inside the side slots in the back. The end plugs are mounted respectively in the ends of the back.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a loose-leaf binder in accordance with the present invention;

FIG. 2 is an exploded perspective view of the loose-leaf binder in FIG. 1;

FIG. 3 is an enlarged cross-sectional end view of the loose-leaf binder along line 3-3 in FIG. 1;

FIG. 4 is an enlarged cross-sectional front view of the loose-leaf binder in FIG. 1; and

FIG. 5 is an exploded perspective view of a conventional loose-leaf binder in accordance with the prior art.

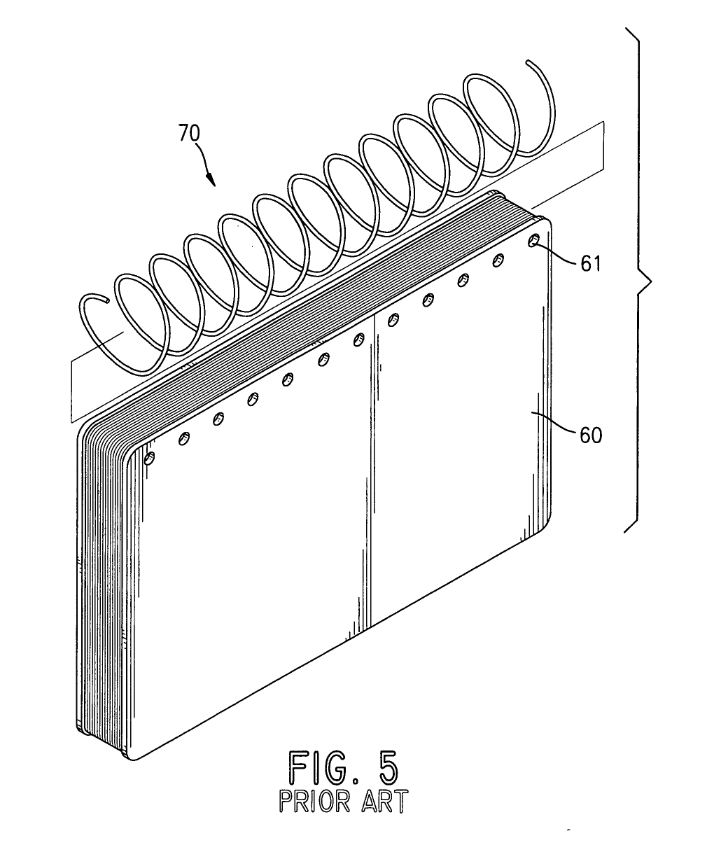

### DETAILED DESCRIPTION OF PREFERRED EMBODIMENT

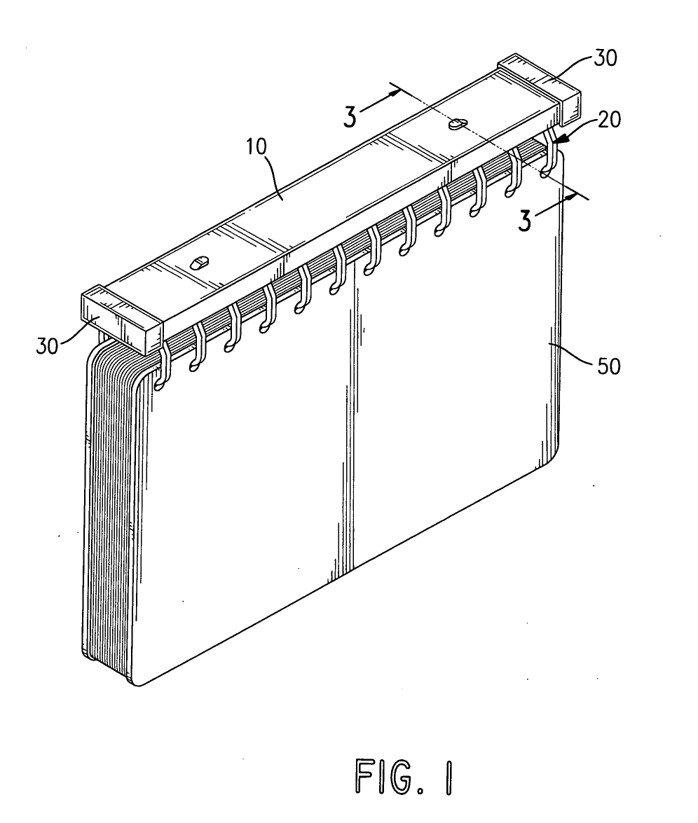

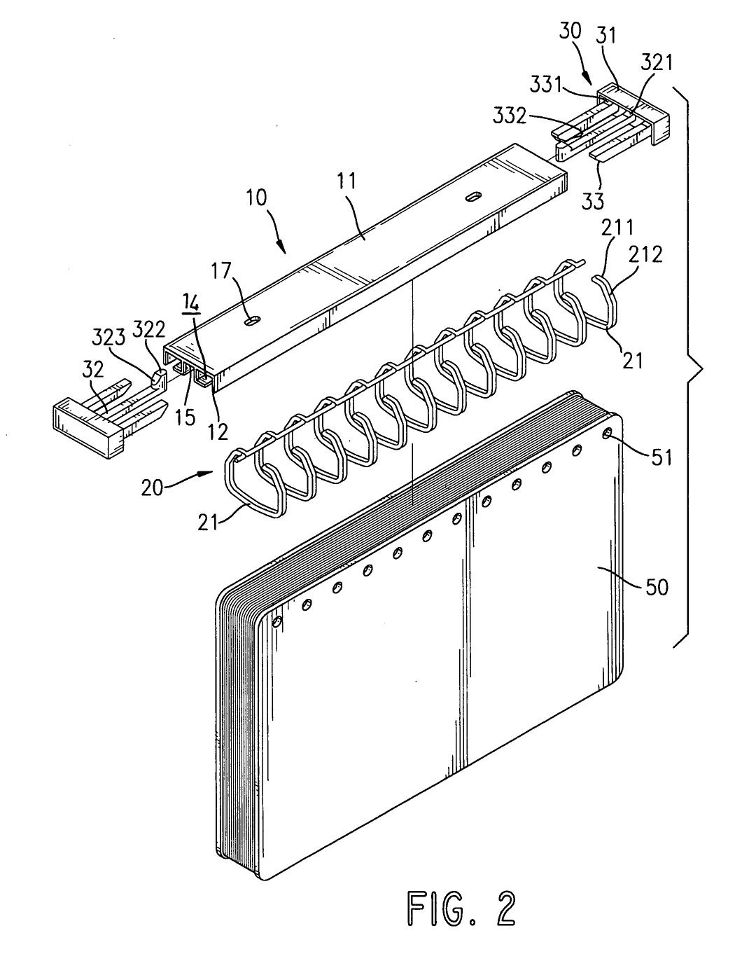

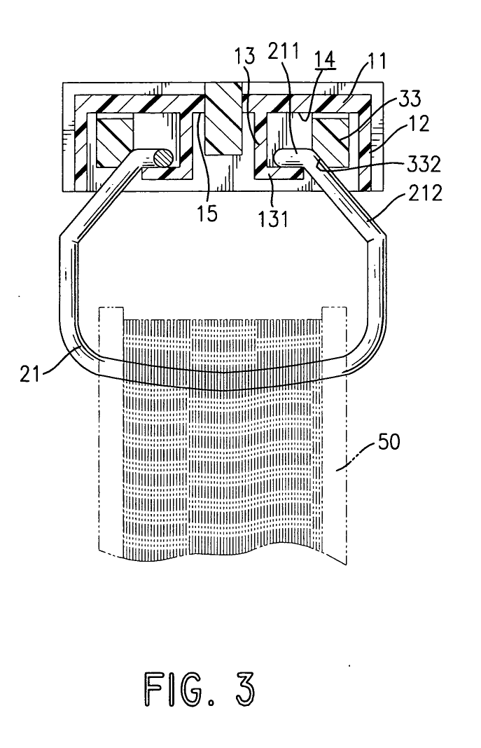

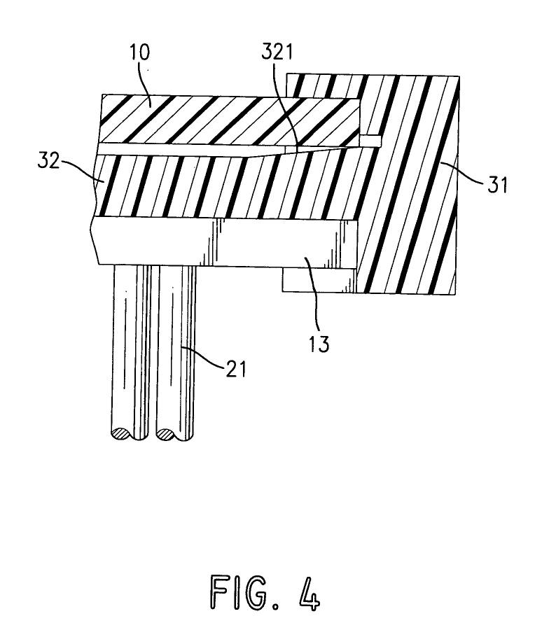

With reference to FIGS. 1, 2, 3 and 4, a loose-leaf binder comprises a back (10), a binder (20) and two end plugs (30).

The back (10) has a spine (11), two skirts (12), two tracks (13), two side slots (14), a middle slot (15) and two ends (not numbered). The spine (11) has a top surface (not numbered), a bottom surface (not numbered), two edges (not numbered) and two through holes (17). The two skirts (12) are defined on the bottom surface of the spine (11) respectively at the edges. The two tracks (13) are defined between the skirts (12). Two longitudinal lips (131) are defined respectively on the tracks (13) and parallel to the spine (11). The two side slots (14) are defined respectively between the corresponding skirts (12) and tracks (13). The middle slot (15) is defined longitudinally between the two tracks (13). The through holes (17) are defined near the ends of the back (10) and communicate with the middle slot (15).

The binder (20) is made of flexible material, is attached to the back (10) and has multiple open rings (21). Each open ring (21) has two ends (not numbered), two level sections (211), and two inclined sections (212). The two level sections (211) are defined respectively on the ends of each open ring (21). The two inclined sections (212) are defined adjacent respectively to the level sections (211) on each open ring (21).

The two end plugs (30) are mounted respectively in the ends of the back (10). Each end plug (30) has a plug cover (31), a middle tine (32) and two side tines (33). The plug covers (31) are attached respectively to the ends of the back (10).

The middle tine (32) extends from the plug cover (31) and has a top (not numbered), a distal end (not numbered), a proximal end (not numbered), a middle inclined compression surface (321) and a latch (322). The proximal end is formed integrally with the plug cover (31). The middle inclined compression surface (321) is defined on the top of the middle tine (32) at the proximal end. The latch (322) is defined at the distal end of the middle tine (32) and has an inclined release surface (323) sloping down toward the corresponding plug cover (31).

The two side tines (33) extend from each plug cover (31) on opposite sides of the middle tine (32). Each side tine (33) has a top (not numbered), a bottom (not numbered), a distal end (not numbered), a proximal end (not numbered), a side inclined compression surface (331) and a sloped groove (332). The proximal end is formed integrally with the plug cover (31). The side inclined compression surface (331) is defined on the top of the side tine (33) at the proximal end. The sloped groove (332) is defined longitudinally in the bottom of the side tine between the distal end and proximal end of each side tine (33) and faces the middle tine (32).

When attaching a notebook (50) with loose-leaf papers (not numbered) having multiple punched holes (5 1) to the loose-leaf binder, the open rings (21) of the binder (20) pass through all the punched holes (51) simultaneously. Then the level sections (211) of the open rings (21) slide into the corresponding side slots (14) from the end of the back (10) and are hooked by the longitudinal lips (131) of the tracks (13) to prevent the level sections (211) from coming off.

When each end plug (30) is inserted into the end of the spine (11), the middle tine (32) and side tines (33) of each end plug (30) are inserted respectively into the middle slot (15) and side slots (14). The side inclined compression surfaces (331) and the middle inclined compression surface (321) are pressed tightly into the end of the spine (11) to hold the end plug (30) in the spine (11). The sloped grooves (332) in the side tines (33) press respectively against the inclined sections (212) of the binder (20) to keep the ends of the open ring (21) from moving transversely inside the side slots (14) and disengaging from the longitudinal lips (131).

When the plug cover (31) abuts the end of the spine (11), the latch (322) of each end plug (30) engages the corresponding through hole (17) to positively hold the end plug (30) in the spine (11).

When detaching or attaching the loose-leaf binder to loose-leafpapers or a notebook (50), the latch (322) is pushed into the corresponding through hole (17), and the end plug (30) is pulled out of the spine (11). The inclined release surface (323) on each latch (322) allows the latches (322) to be pulled out of the through holes (17) without having to push the latches (322) completely through the through holes (17). Therefore, the end plug (30) may be detached easily from the back (10). Consequently, the back (10) and the notebook (50) can be separated quickly.

The back (10) can be easily slid off or onto the binder (20). Furthermore, the end plug (30) with the latch (322) having the inclined release surface (323) may be separated easily from the end of the spine (11) by hand. Therefore, the loose-leaf papers or the notebook can be detached from or attached to the loose-leaf binder quickly and save time.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A loose-leaf binder comprising:
a back having
two ends;
a spine having a top surface, a bottom surface, two edges and two through holes defined near the ends of the back;
two skirts defined respectively on the bottom surface respectively at the edges of the spine;
two tracks defined between the side skirts on the bottom surface of the spine, wherein two longitudinal lips are defined respectively on the tracks and parallel to the spine;
two side slots defined respectively between the corresponding side skirts and tracks; and
a middle slot defined longitudinally between the tracks;
a binder made of a flexible material, attached to the back, having
multiple open rings detachably attached to the back, each having
two ends;
two level sections defined respectively on the ends of the open rings; and
two inclined sections defined adjacent respectively to the level sections of the open rings; and
two end plugs mounted respectively in the ends of the back and each having
a plug cover attached to one of the ends of the back;
a middle tine extending from the plug cover, having
a top;
a distal end;
a proximal end formed integrally with the plug cover;
a middle inclined compression surface is defined on the top of the middle tine at the proximal end; and
a latch defined at the distal end and having an inclined release surface sloping down toward the corresponding plug cover; and
two side tines extending from the plug cover on opposite sides of the middle tine and each having
a top;
a bottom;
a distal end;
a proximal end formed integrally with the plug cover;
a side inclined compression surface defined on the top of the side tine at the proximal end; and
a sloped groove defined longitudinally in the bottom of the side tine between the distal end and proximal end of the side tine and facing the middle tine.
